(19) United States
(12) Patent Application Publication
(10) Pub. No.: US 2017/0373992 A1
(43) Pub. Date: Dec. 28, 2017

(54) DIGITAL INTERACTION PROCESS AUTOMATION

(71) Applicant: Clickatell Corporation, Redwood City, CA (US)

(72) Inventor: Nirmal Nair, San Jose, CA (US)

(21) Appl. No.: 15/630,500

(22) Filed: Jun. 22, 2017

Related U.S. Application Data
(60) Provisional application No. 62/353,170, filed on Jun. 22, 2016.

(51) Int. Cl. H04L 12/58; H04L 29/06; H04L 29/08

(52) U.S. Cl. CPC H04L 51/02; H04L 67/06; H04L 63/06; H04L 63/0861; H04L 63/105

(57) ABSTRACT

In various example embodiments, a system and method for digital interaction process automation are presented. A card template file is downloaded to a communications application hosted on a user device. A plurality of card files is loaded into a card container within the communications application. A communications card within the communications application is rendered.

### RELATED APPLICATIONS

This application claims the priority benefit of U.S. Provisional Application No. 62/353,170, entitled “CARD-BASED CHAT STREAMS,” filed Jun. 22, 2017, which is hereby incorporated herein by reference in its entirety.

### TECHNICAL FIELD

Embodiments of the present disclosure generally relates to the technical field of special-purpose machines that facilitate interactions with digital process automation systems including computerized variants of such special-purpose machines and improvements to such variants, and to the technologies by which such special-purpose machines become improved compared to other special-purpose machines that facilitate interactions with the digital process automation systems. Specifically, the present disclosure addresses systems and methods to facilitate digital process automation.

### BACKGROUND

Conventionally, a business transaction may occur a business entity and a customer. However, there are no standard or streamlined methods to break up business transactions into self-contained portions that can then be re-ordered or presented per the contextual needs of a business communication. Instead, conventional web and native mobile applications present a rigid and comprehensive structure. On the other extreme, some conventional chat streams provide a free form unstructured conversation which is tedious and impractical if business transactions are involved. As a result, these conventional applications are unable to address the contextual needs of the business communication.

### BRIEF SUMMARY

in some embodiments, a method may include downloading card template files to a communications application hosted on a user device, loading a group of card files into a card container within the communications application, rendering a card within the communications application, receiving user input via the card, and/or communicating the user input from the card to the group of web services.

In some embodiments, the methods described herein allows for performing varying complex and structured business transactions within an unstructured chat stream. The chat streams could be through social media such as, but not limited to, Twitter, Facebook Pages, Facebook messenger, WhatsApp and Apple Business Chat. The methods described herein allows for business and consumers to communicate freely and seamlessly jump into a structured transaction as the context demands. The technology allows for businesses to create a manual, semi-automated or fully automated business process and deliver to consumers to consume and interact with on demand and in real time either during live conversations or in a self-serve mode. The applicability of the methods described is across customer service, e-commerce and customer engagement business use cases.

In some embodiments, the rendering of the card may include retrieving an application context from the card container and/or retrieving further data from a group of web services.

In some embodiments, the card is rendered using JavaScriptCore. Moreover, in some embodiments, the JavaScriptCore is specific to an operating system (e.g., Apple iOS operating system).

In some embodiments, a method to construct a card at a card server, the card for use in a card-based chat message stream is described herein, the method including receiving card template files at the communications server, assigning instructions to the card template files for commands and user actions, packaging the card template files for delivery to a communications application on a client device, and/or adding the packaged card template files to a card management system associated with an entity.

In some embodiments, the receiving of the card template files is automated through an artificial intelligence system component (TIE—Touch Intent Engine) which may include machine learning and natural language processing (NLP) techniques to understand the unstructured customer query and map it to an automated business process flow.

In some embodiments, the user input and chat conversation could take place using social media mobile and web based platforms such as (hut not limited to) Twitter, Facebook Pages, Facebook Messenger, WhatsApp or Apple Business Chat. In such an embodiment, the unstructured or free flow customer query (e.g., a chat message) would be automatically interpreted by an artificial intelligence component of the system and responded through a combination of plain text, HTML, user interface elements or by human agents of the business that is using the process to serve the needs of its customers.

In some embodiments, the presentation of business process flow (e.g., user authentication or retrieval of information from a separate enterprise system) will be governed by a business process as defined by BPMN 2.0 standard and executed by a BPMN complaint workflow engine.

In some embodiments, the presentation of business process flow can be done manually by a business agent using a unified agent desktop software

In some embodiments, the unstructured user input will be automatically analyzed by the artificial intelligence component for intent recognition, entity recognition, and sentiment recognition. For intent recognition, the artificial intelligence component will determine what the user wants. With regards to entity recognition, the entities being recognized by the artificial intelligence component may include common language objects (e.g., places, time, things) and/or business specific objects (e.g., a checking account for a bank, policy meaning insurance policy for insurance companies). The artificial intelligence component may also perform sentiment recognition to determine a sentiment of the user (e.g., positive, negative or neutral) from the user input. Such analysis will then be used by the business process flow or human agents to provide an appropriate response using cards or plain text, which is presented back to the user within the same chat application or stream through which the user contacted the business.

In some embodiments, the receiving of the card template files may include receiving a description of the card presentation user interface in standard web technology formats (e.g., HTML, CSS, or JavaScript), the actions if any that are available for the viewer of the card (e.g., button press, or choice selections) and the actions if any that will take place as a result of user interactions (e.g., result of the user selection).

In some embodiments, the assigning of instructions to the card template files may include assigning JavaScript code to the card template files for the commands and user actions. The JavaScript code controls the actions that will need to be performed when the user invokes a user interface component on the card (e.g., pressing a button or a switch on the card).

In some embodiments, the receiving of the card template files at the communication server may include detecting selection of a pre-existing card template files and detecting editing of the pre-existing card template file to generate the received card template file.

In some embodiments, the receiving of the card template files at the communications server may include receiving selection of a first type of standard card template file from a group of different types of standard card template files available for selection at the communications server.

In some embodiments, a method to perform user self-identification within a card-based chat message stream may include: receiving, at a communications application and from a communications server, a request from an agent to a user of the communications application to self-identify; receiving authentication credentials from the user in order to unlock stored identification information stored on a user device associated with the communications application; responsive to receipt of the authentication credentials, auto-populating the identity card with the stored identification information in order to generate a populated identity card; receiving from the user a submission indication to submit the populated identity card; responsive to the submission indication, transmitting of the populated identity card to the communications server in order to authenticate the user; and/or displaying, at the communications application, acceptance of the populated identity card.

In some embodiments, the request may include an identity card that is presented to the user via the communications application for input of identification information.

In some embodiments, the receiving of the authentication credentials may include receiving a security key from the user responsive to a security challenge.

In some embodiments, the security key may include a visual CAPTCHA identification method.

In some embodiments, the security key may include a fingerprint.

In some embodiments, the security key may include a voice signature.

In some embodiments, the stored identification information is stored in an encrypted form on the user device associated with the communications application.

In some embodiments, the stored identification information may include a first identification information having a first degree of protection and second identification information having a second the degree of protection.

In some embodiments, the method may include detecting no stored identification information on the user device, responsive to the detecting of no stored identification information stored on the user device, prompting the user to input received identification information, and storing the received identification information as the stored identification information.

In some embodiments, the identity card presents a group of fields to receive the stored identification information.

In some embodiments, the quality of fields may be auto-populated responsive to receipt of the authentication credentials.

In some embodiments, the identity card presents a business field to receive business-specific information related to a business associated with the agent.

In some embodiments, the method may include receiving the business-specific information from the user into the identity card, and storing of the business-specific information on the user device associated with the communications application.

in some embodiments, a method to facilitate a card-based chat message stream may include: receiving a card template file at a communications application executing on a client device; unpacking and loading the card template file within context of the communications application; identifying a card container associated with the card template file, and attaching the card template file to the card container; extracting application context from the card container; populating the card template file with the extracted application context to generate an instantiated card; detecting user manipulation of the instantiated card; and/or responsive to the user manipulation, generating a call from the communications application to the communication server.

In some embodiments, the card template file may be received as part of the chat message stream between the communications application and a communication server.

In some embodiments, the card template file is received at the at the communications application using over-the-air (OTA) programming.

In some embodiments, this methods described herein allow for structured business transactions within an unstructured chat stream. This allows for business and consumers to communicate freely and seamlessly jump into a structured transaction as the context demands. The allows for businesses to create any business process and deliver to consumers cards to consume and interact with on demand and in real time either during live conversations or in a self-serve mode.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating a networked system, according to some example embodiments.

FIG. 2 is a block diagram illustrating further view of networked system of FIG. 1, according to some example embodiments,

IVIG. 3 is a diagrammatic representation of the association of a particular business with a contact hot, and a number of agents, that service respective groups of consumers (e.g., customers) of the relevant business.

FIG. 4 is a diagrammatic representation of a communications card architecture, according to some example embodiments.

FIG. 5 is a block diagram illustrating the communication of cards, for use in a chat-based communication stream, between various entities in a communication ecosystem. In the illustrated example, an agent computer 502, chat bot 504, and card designer 506 are all associated with a common entity (e.g. a business) that communicates, via a chat stream supported by a communications server 508, with a user of a client device 514. A card designer 506 accesses the communications server 508 in order to create and edit cards, associated with a particular business that are stored in a card repository 510. The agent computer 502 and the chat bot 504 push cards 516, on-demand and via a communications server 508, to a client device 514 to be displayed by a communications application (e.g., a chat client application) executing on the client device 514. The communications application also has the ability to pull cards on demand from the card repository 510.

FIG. 6 shows a series of screenshots of card-based user interfaces that may be presented by a communications application, according to some example embodiments.

FIG. 7 are screenshots showing a collection of further example cards that may be presented by a communications application within the context of a card-based chat stream.

FIG. 8 illustrates a routine in accordance with one embodiment.

FIG. 9 illustrates a routine in accordance with one embodiment.

FIG. 10 illustrates a routine in accordance with one embodiment.

FIG. 11 illustrates a routine in accordance with one embodiment.

FIG. 12 is a block diagram illustrating a representative software architecture software architecture, which may be used in conjunction with various hardware architectures herein described.

FIG. 13 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

### GLOSSARY

“ADMINISTRATOR” in this context refers to a person or entity is a supervisory role (e.g., with respect to a chat SaaS deployment).

“TIE” or “Touch Intent Engine” in this context refers to the Artifical Intelligence component of the system that performs Intent, Entity and Sentiment recognition based on the user input.

“TAF” or “Touch Automation Framework” in this context refers to the automated business workflow description and execution engine that controls the decision flow, information and task routing of an automated business flow.

“CHAT STREAM” in this context refers to any chat based application such as, but not limited to, social media applications such as Twitter, Facehook Messenger or Apple Business Chat that are possible to be integrated to the Touch system through APIs.

“AGENT” in this context refers to is a person that represents an entity (e.g., a business). An agent may be a contact center employee.

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (CPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“CONSUMER” in this context refers to a customer of a tenant. A customer can connect with multiple tenants.

“CONTACT BOT” in this context refers to an automated responder that represents a business or entity. A contact bot may perform basic look-up queries, divert network or communications traffic, answer questions etc., and may include an artificial intelligence (AI) component

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors(sometimes referred to as “cores”) that may execute instructions contemporaneously.

“SOFTWARE MULTITENANCY” in this context refers to a software architecture in which a single instance of software runs on a server and serves multiple tenants,

“TENANT” in this context refers to a user or group of users who share a common access with specific privileges to a software instance in a multitenancy software architecture.

### Description

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2016, CLICKATELL (PTY) LTD., All Rights Reserved.

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

### Drawings

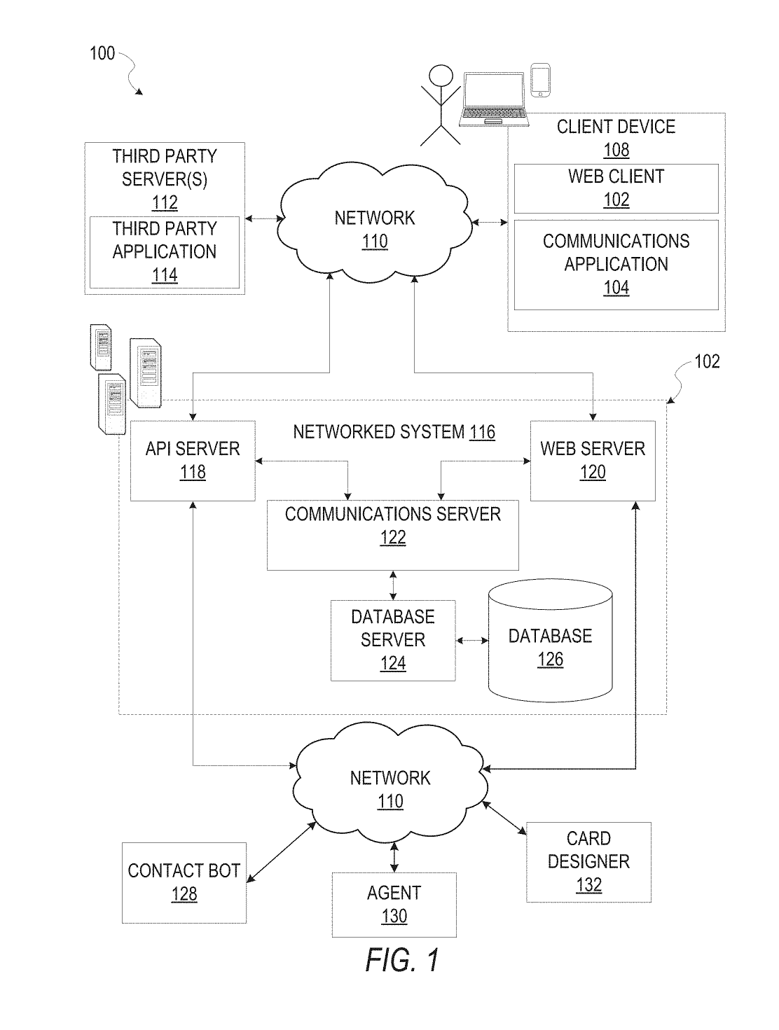

With reference to FIG. 1, an example embodiment of a high-level SaaS network architecture 100 is shown.

At a high level, the SaaS network architecture 100 provides a solution for customer care built on the convergence cloud. The deployment of a chat-enabled communications server 122 operates to facilitate communications between a number of consumers, via a number of channels, atop a messaging service supported by the communications server 122. In some example embodiments, the SaaS network architecture 100 seeks to address a number of the technical challenges presented by current customer care solutions and platforms. Specifically, in some example embodiments, the SaaS network architecture 100 seeks to provide a platform that enables a consumer to complete a task at hand without leaving the context of that task. Some embodiments also seek to present a simpler way for consumers to interact with businesses, and to bring value to consumers that goes beyond conversations. Back and forth conversations may be inefficient and are sometimes not natural. Consumers are increasingly demanding the communications with the businesses be as efficient as possible, but at the same time are familiar with the conversational chat paradigm. Example embodiments of the present invention seek to address some of the technical challenges present in current chat technologies and platforms

A networked system 116 provides server-side functionality via a network 110 (e.g., the Internet or wide area network (WAN)) to a client device 108. A web client 102 and a programmatic client, in the example form of a communications application 104, are hosted and execute on the client device 108. The networked system 116 includes a communications server 122 that provides a number of communications (e.g., chat) functions and services to the communications application 104.

The client device 108 enables a user to access and interact with the networked system 116. For instance, the user provides input (e.g., touch screen input or alphanumeric input) to the client device 108, and the input is communicated to the networked system 116 via the network 110. The networked system 116, in response to receiving the input from the user, communicates information back to the client device 108 via the network 110 to be presented to the user.

An Application Program Interface (API) server 118 and a web server 120 are coupled to, and provide programmatic and web interfaces respectively, to the communications server 122. The communications server 122 is, in turn, shown to be coupled to a database server 124 that facilitates access to information storage repositories (e.g., a database 126). In an example embodiment, the database 126 includes storage devices that store information accessed and generated by communications server 122.

Additionally, a third party application 114, executing on a third party server 112, is shown as having programmatic access to the networked system 116 via the programmatic interface provided by the Application Program Interface (API) server 118. For example, the third party application 114, using information retrieved from the networked system 116, may support one or more features or functions on a website hosted by the third party.

Turning now specifically to the applications hosted by the client device 108, the web client 102 accesses the communications server 122 via the web interface supported by the web server 120. Similarly, the communications application 104 (e.g., an “app”) accesses the various services and functions provided by communications server 122 via the programmatic interface provided by the Application Program Interface (API) server 118. The communications application 104 may, for example, be an “app” such as an iOS or Android OS application executing on a client device 108. The communications application 104 enables user to access and input data on the networked system 116 in both an on-line manner and an off-line manner, and to perform batch-mode communications between the programmatic client communications application 104 and the networked system 116.

A number of different versions of the communications application 104 may be hosted on a number of different types of client devices, each of the types of client devices providing a different customer “channels”. For example, a client device 108 may be a mobile telephone, a fitness tracker, a laptop computer or the like.

A contact bot 128, an agent 130 and a card designer 132 are also communicatively^{,} coupled to the communications server 122 via the network 110 and the Application Program interface (API) server 118 and/or the web server 120. The contact bot 128, as described in further detail below, is an automated representative of a business (or other entity), and acts as automated responder on the behalf of a particular business, and may perform basic lookup queries, traffic diversion and question answering functions. The agent 130 is a human representative of business (or other entity) and is typically a contact center employee. The card designer 132 is a designer responsible for the design and creation of various contact cards that may be presented, by the communications server 122 to a user of the client device 108 via the communications application 104.

Further, while the SaaS network architecture 100 shown in FIG. 1 employs a client-server architecture, embodiments are of course not limited to such an architecture, and could equally well find application in a distributed, or peer-to-peer, architecture system, for example.

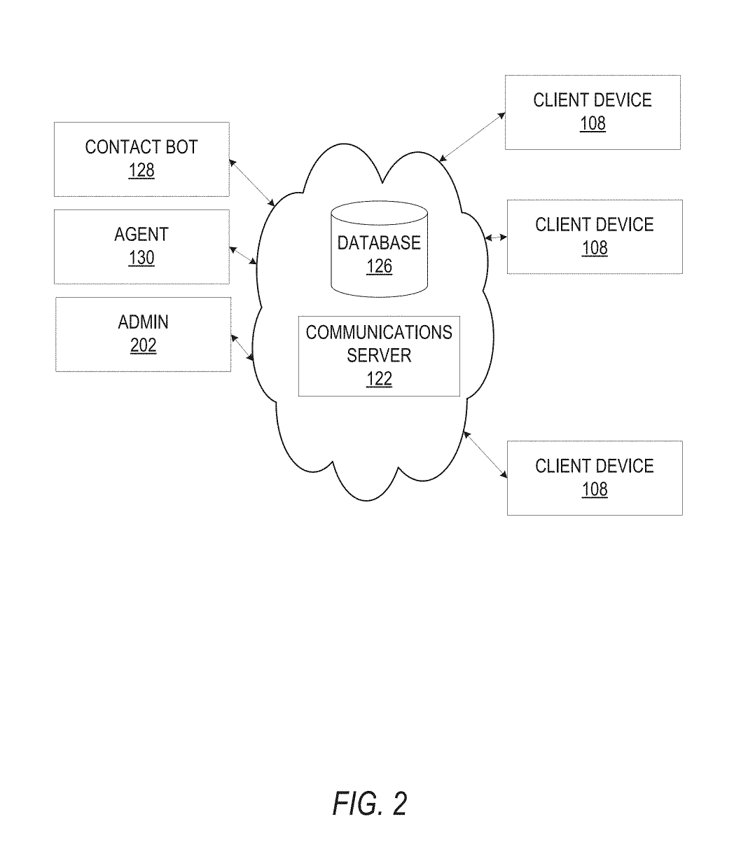

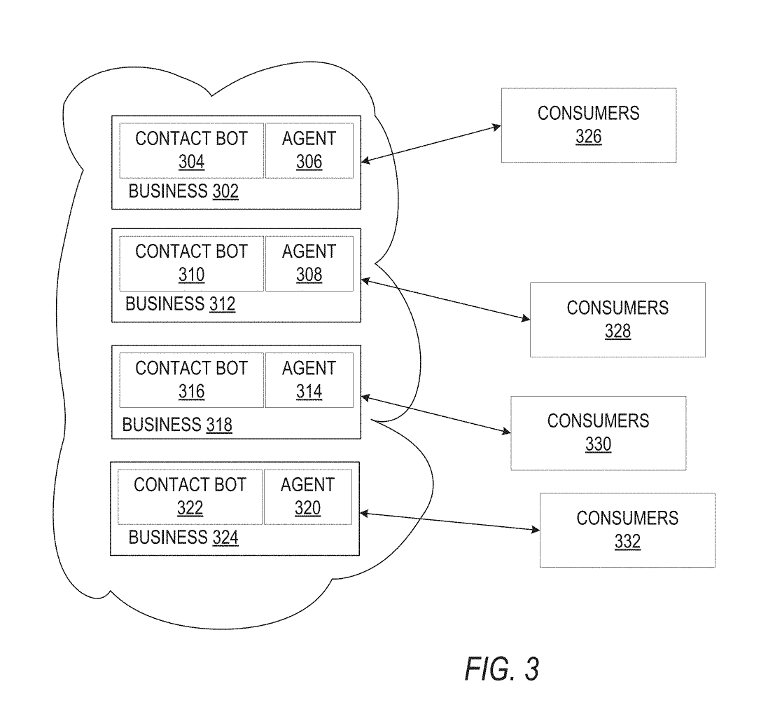

FIG. 2 is a block diagram illustrating further view of networked system of FIG. 1, according to some example embodiments.

FIG. 2 illustrates a number of different types of client device 108, as well as an administrator 202 being coupled to the communications server 122. The administrator 202 is typically a human supervisor or IT professional in charge of deployment of the contact technology supported by the communications server 122.

FIG. 3 is a diagrammatic representation of the association of a particular business with a contact bot (e.g., the automated representative of the business and a number of agents (e.g., a group of human representatives of the business), the bot and the agents collectively providing contact services to respective groups of consumers (e.g., customers) of the relevant business.

FIG. 3 shows multiple tenants being posted on a contact cloud 334 (e.g., supported by the communications server 122 and associated cloud infrastructure). For example, business 302 has an associated contact bot 304 and a number of agents 306, which interact with a collection of consumers 326 (e.g., customers) of the business 302. Similarly, each of business 312, business 318 and business 324 have an associated contact bot and collection of agents to interact with their consumers.

Consumers (e.g., consumers 326-consumers 332) are able to discover tenants (e.g., business 302-business 324) through a searchable listing service provided by the cloud 334. Each tenant has an associated and representative contact bot (e.g., contact bot 304-contact bot 322) as well as a variable number of live agents (e.g., agents 306-agents 320) which may be web-based XMPP clients. A variable number of consumers connected to each of the businesses through a communications application 104 posted on a user device, An individual consumer may start a multi-party chat room on a connection with a contact bot and/or an agent. Each consumer is only in one chat room per tenant, while agents may be present in multiple chat rooms. For particular business, a single contact bot is present in every chat room associated with that business.

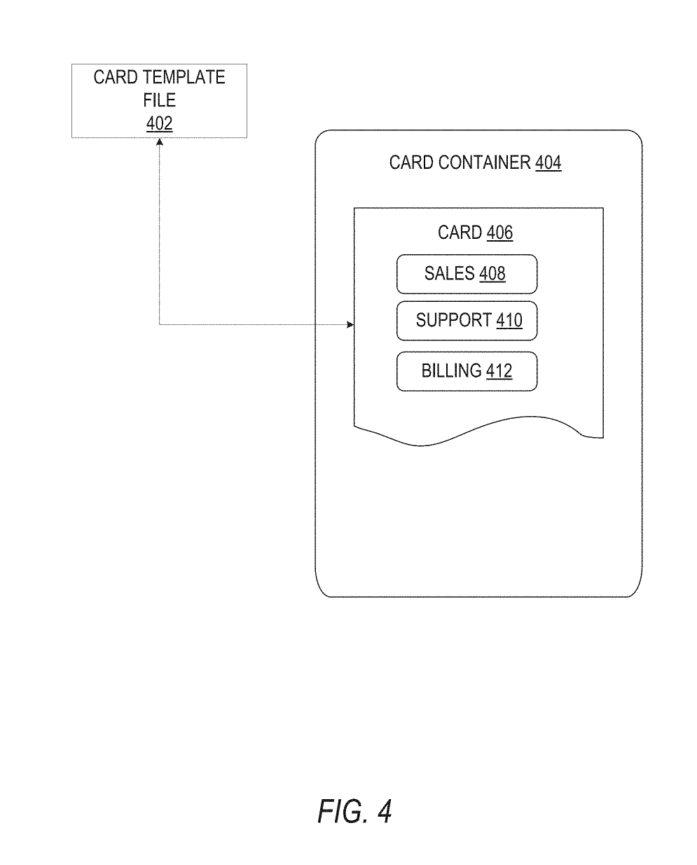

FIG. 4 is a diagrammatic representation of a contact card architecture, according to some example embodiments.

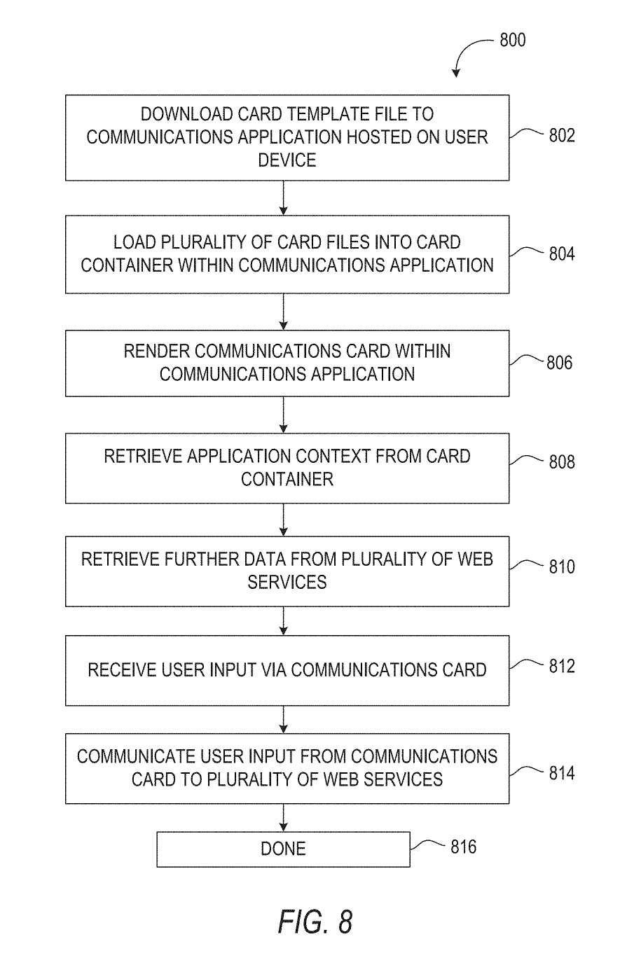

A card container 404 is a native and JavaScriptCore class, and communicates an application context to a card 406 through a standard interface. The card container 404 also provides access to native operating system (e.g., iOS) calls for those not covered by React Native. Instantiation and operations of the card 406 will now be described herein with reference to FIG. 8.

A card template file 402 for a specific card 406 is downloaded from the communications server 122 by the communications application 104, and resides within the communications server 122 for a predetermined and/or a variable amount of time. Updates to a card template file 402. are updated on demand, and the communications application 104 periodically checks for updates to the card template file 402 for each card 406 resident on the communications application 104.

A particular card 406 may be dynamic in nature, and generated on the fly by the communications server 122 based on a number of factors, including user context. The ability to generate a dynamic card 406 results in a highly contextualized and uncluttered the user interface. This provides a particular technical advantage within the context of mobile devices, as one user interface size does not fit all in view of the limited use interface display size and the inability to scale. The ability to generate a dynamic card 406 also enables localization.

It should be noted that every card 406 has included data regarding its specific lifecycle, and card updates are immediately synchronized to the cards running on the communications server 122.

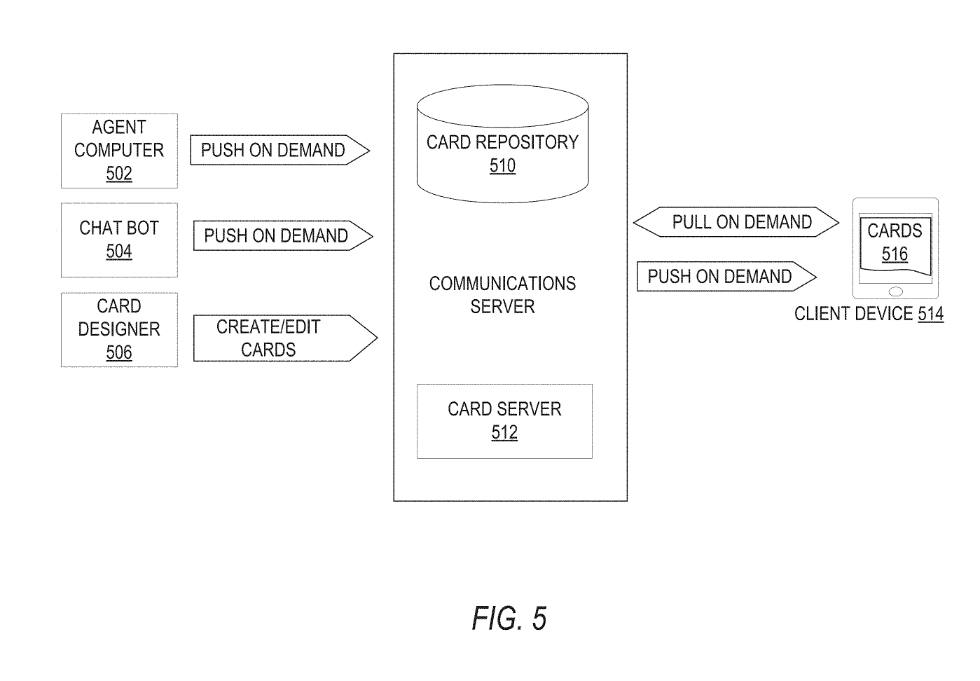

FIG. 5 is a block diagram illustrating the communication of cards, for use in a chat-based communication stream, between various entities in a communication ecosystem 500.

In the illustrated example, an agent computer 502, chat bot, and card designer 506 are all associated with a common entity (e.g. a business) that communicates, via a chat stream supported by a communications server 508, with a user of a client device 514.

A card designer 506 accesses the communications server 508 in order to create and edit cards, associated with a particular business on that are stored in a card repository 510.

The agent computer 502 and the chat bot 504 push cards 516, on-demand and via a communications server 508, to a client device 514 to be displayed by a communications application (e.g., a chat client application) executing on the client device 514. The communications application also has the ability to pull cards 516 on demand from the card repository 510.

In the illustrated example, an agent computer 502, chat hot 504, and card designer 506 are all associated with a common entity (e.g. a business) that communicates, via a chat stream supported by a communications server 508, with a user of a client device 514.

A card designer 506 accesses the communications server 508 in order to create and edit cards, associated with a particular business on that are stored in a card repository 510.

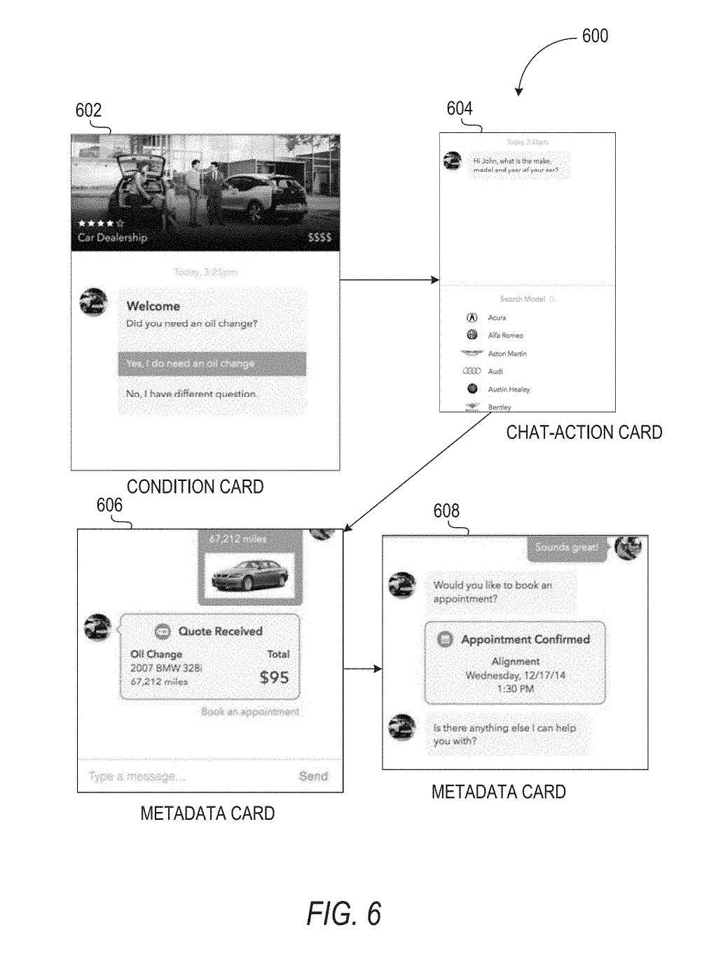

FIG. 6 shows a series of screenshots of card-based user interfaces that may be presented by a communications application 104, according to some example embodiments.

In the shown example, a communications application 104 facilitates a card-based chat session between an entity (e.g. a car dealership or other auto-repair business) represented by a human agent and/or an automated agent (e.g., a chat bot) via a communications server 122.

The communications application 104 receives a number of cards in the context of a chat stream that are presented within the user interface. These cards include a condition card 602 to receive user input that either satisfies or does not satisfy a particular condition (e.g., does the user need an oil change for their car or not). Based on the satisfaction of the condition, a business workflow that integrates with the card presentation, causes the communications application 104 to present a chat-action card 604. The chat-action card 604, in the example is presented by a contact bot 128, and prompts the user to identify a make, model and year of a car.

Based on the information provided via the chat-action card 604, a first metadata card 606 is presented that displays response information to the user. In the example, quote information is presented within the metadata card 606.

The contact bot 128 may then present a second metadata card 608, which may prompt the user for further confirmation information (e.g., “Would you like to book an appointment?”), as well as present appointment confirmation information. The metadata card 608 is also shown to query the user regarding any further help that may be needed. A positive response from the user may trigger a further workflow and the presentation of associated cards within a subsequent branch chat stream.

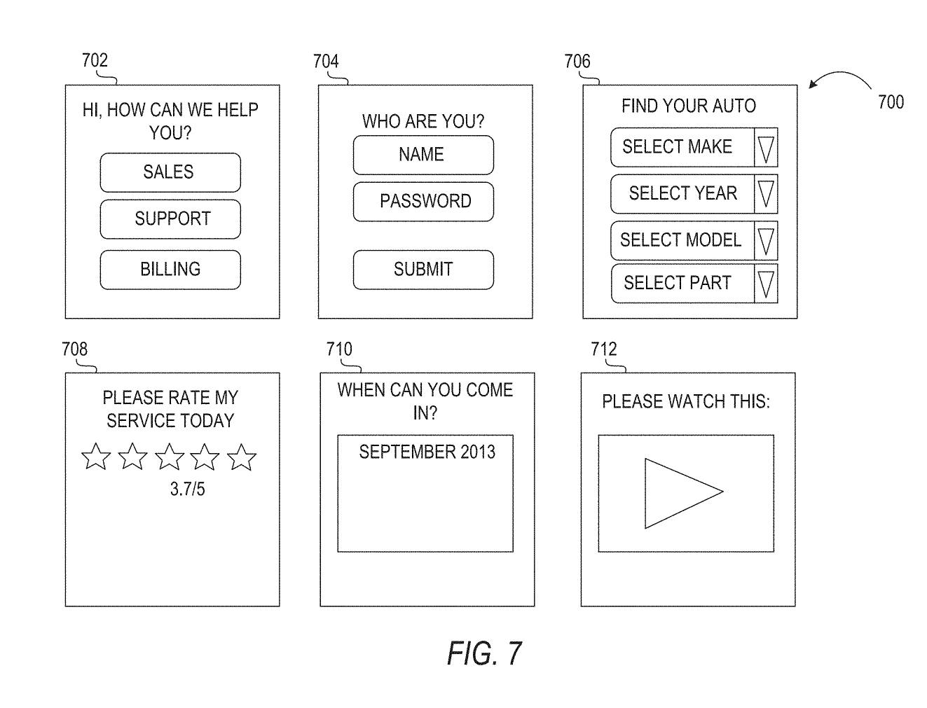

FIG. 7 are screenshots showing a collection of further example cards that may be presented by a communications application within the context of a card-based chat stream. In other words, the communications server 122 may cause display of each of the example cards 702, 704, 706, 708, 710, and 712 to the communications application 104 within the context of the card-based chat stream.

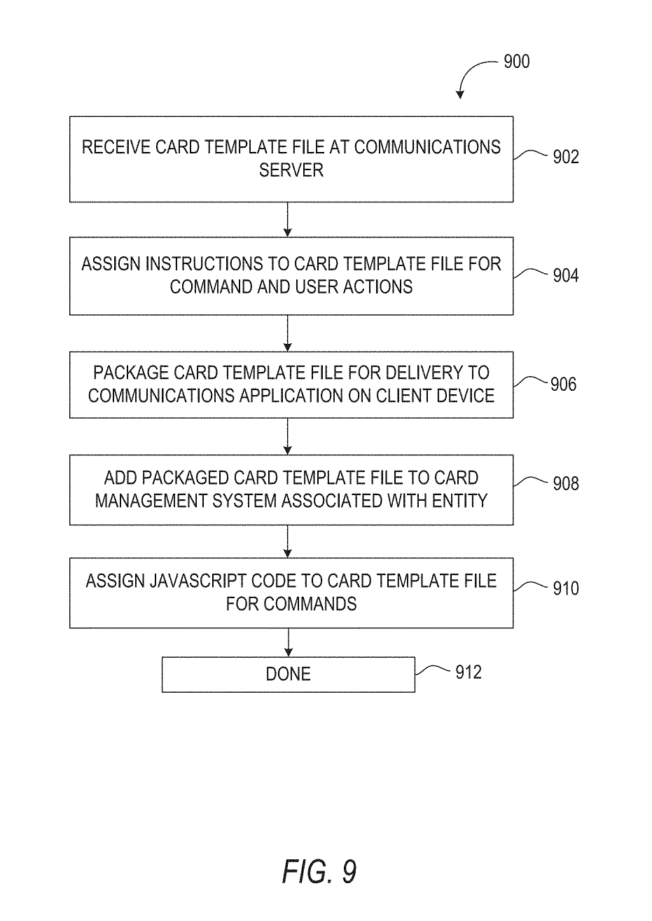

FIGS. 8-9 are flowcharts illustrating operations of the communications server 122 in performing one or more routines, according to some example embodiments. Operations in the routines 800 or 900 may be performed in part or in whole the communications server 122. Accordingly, the routines 800 or 900 are described by way of example with reference to the communications server 122. However, it shall be appreciated that at least some of the operations may be deployed on various other hardware configurations or be performed by similar components residing elsewhere.

In block 802, routine 800 downloads a card template file to a communications application hosted on a user device. In block 804, routine 800 loads a plurality of card files intL a card container within the communications application. In block 806, routine 800 renders a communications card within the communications application. In block 808, routine 800 retrieves an application context from the card container. In some instances, the application context indicates a specific chat stream being used by the communications application. The application context may also indicate a type of transaction being performed within the chat stream.

In block 810, routine 800 retrieves further data from a plurality of web services. In block 812, routine 800 receives user input via the communications card. In block 814, routine 800 communicates the user input from the communications card to the plurality of web services. In done block 816, routine 800 ends.

In block 902, routine 900 receives a card template file at the communications server. The receiving of the card template file may include detecting selection of a pre-existing card template file. The receiving of the card template file may also include detecting an editing of the pre-existing card template file, which generates the received card template file. In some embodiments, the receiving of the card template files is automated through the artificial intelligence system component (TIE—Touch Intent Engine). In some embodiments, the artificial intelligence system component resides in the communications server 122.

In block 904, routine 900 assigns instructions to the card template file for commands and user actions. In some instances, the commands and user actions are predefined options for a user to select and the commands and user actions may correspond to a particular context of a chat stream. In block 906, routine 900 packages the card template file for delivery to a communications application on a client device. In block 908, routine 900 adds the packaged card template file to a card management system associated with an entity. In block 910, routine 900 assigns JavaScript code to the card template file for the commands. In done block 912, routine 900 ends.

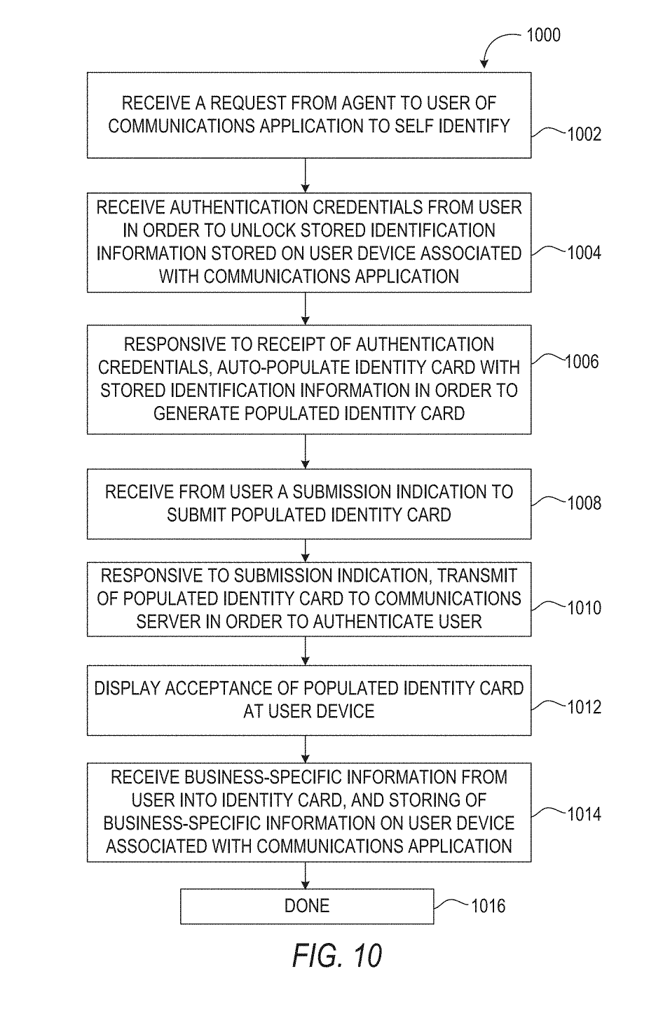

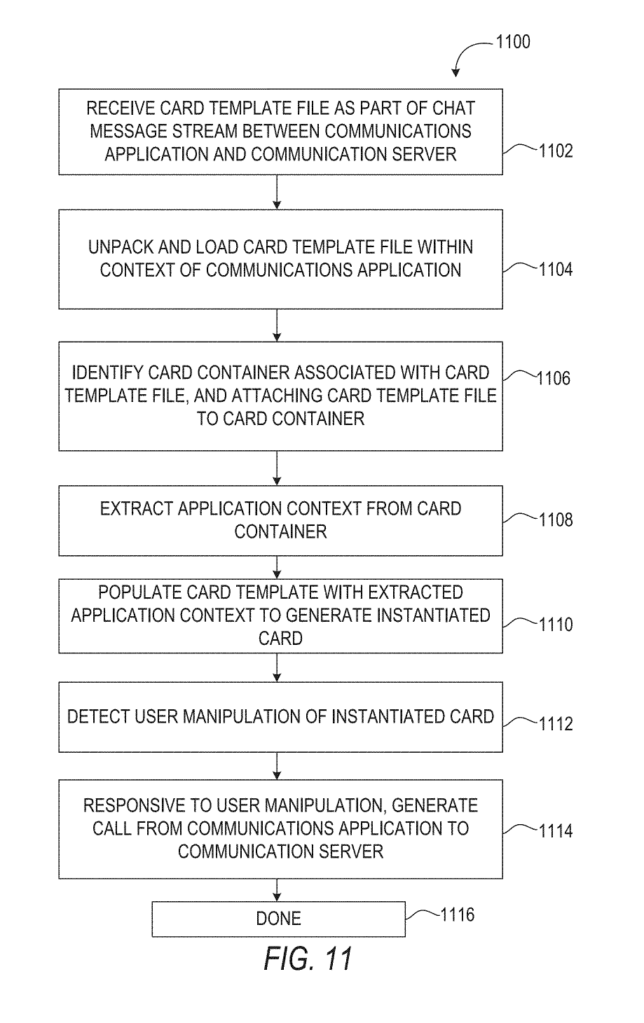

FIGS. 10-11 are flowcharts illustrating operations of the communications application 104 in performing one or more routines, according to some example embodiments. Operations in the routines 1000 or 1100 may be performed in part or in whole communications application 104. Accordingly, the routines 1000 or 1100 are described by way of example with reference to the communications application 104. However, it shall be appreciated that at least some of the operations may be deployed on various other hardware configurations or be performed by similar components residing elsewhere.

In block 1002, routine 1000 at a communications application and from a communications server, receives a request from an agent to a user of the communications application to self-identify. In block 1004, routine 1000 receives authentication credentials from the user in order to unlock stored identification information stored on a user device associated with the communications application. In block 1006, routine 1000 responsive to receipt of the authentication credentials, auto-populates the identity card with the stored identification information in order to generate a populated identity card. In block 1008, routine 1000 receives from the user a submission indication to submit the populated identity card. In block 1010, routine 1000 responsive to the submission indication, transmits the populated identity card to the communications server in order to authenticate the user. In block 1012, routine 1000 displays acceptance of the populated identity card at the user device. In block 1014, routine 1000 receives the business-specific information from the user into the identity card, and stores of the business-specific information on the user device associated with the communications application. In done block 1016, routine 1000 ends.

In block 1102, routine 1100 at communications application executes on a client device, receiving a card template file as part of the chat message stream between the communications application and a communication server. In block 1104, routine 1100 unpacks and loads the card template file within context of the communications application. In block 1106, routine 1100 identifies a card container associated with the card template file, and attaching the card template file to the card container. In block 1108, routine 1100 extracts application context from the card container. In block 1110, routine 1100 populates the card template file with the extracted application context to generate an instantiated card. In block 1112, routine 1100 detects user manipulation of the instantiated card. In block 1114, routine 1100 responsive to the user manipulation, generates a call from the communications application to the communication server. In done block 1116, routine 1100 ends.

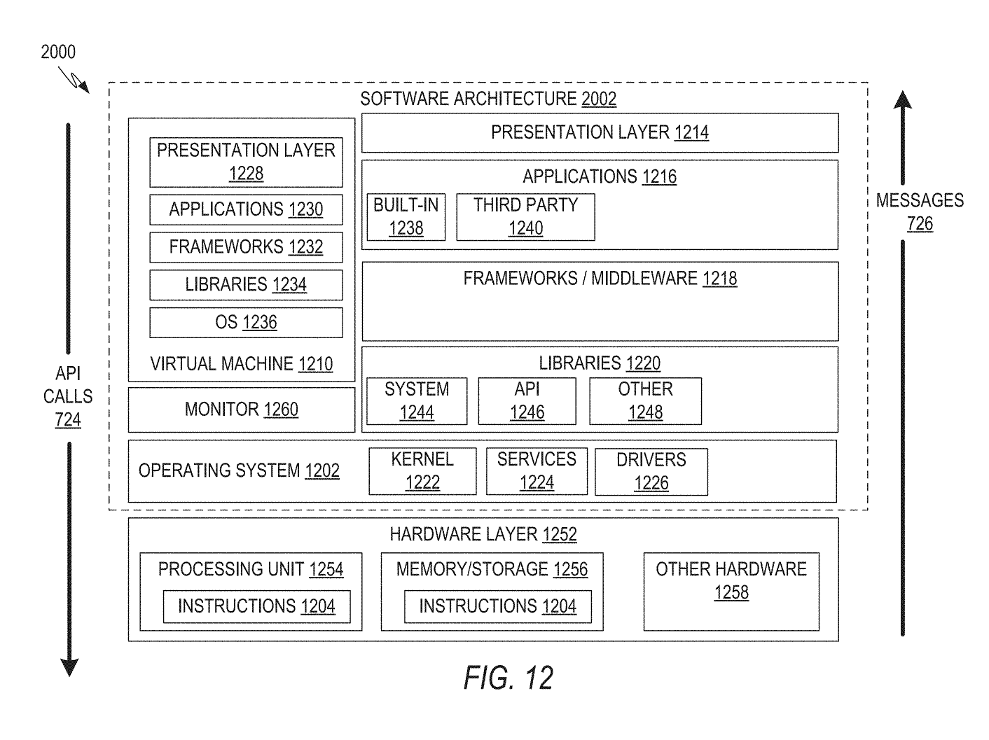

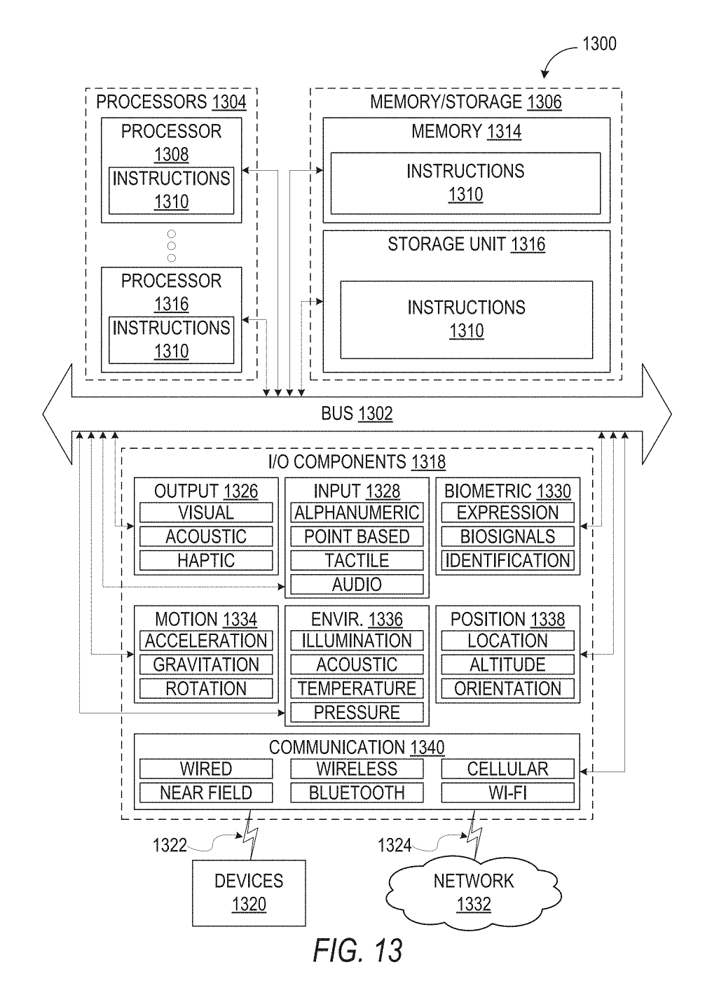

FIG. 12 is a block diagram illustrating an example software architecture 1206, which may be used in conjunction with various hardware architectures herein described. FIG. 12 is a non-limiting example of a software architecture and it will be appreciated that many other architectures may be implemented to facilitate the functionality described herein. The software architecture 1206 may execute on hardware such as machine 1300 of FIG. 13 that includes, among other things, processors 1304, memory 1314, and I/O components 1318. A representative hardware layer 1252 is illustrated and can represent, for example, the machine 1300 of FIG. 13. The representative hardware layer 1252 includes a processing unit 1254 having associated executable instructions 1204. Executable instructions 1204 represent the executable instructions of the software architecture 1206, including implementation of the methods, components and so forth described herein. The hardware layer 1252 also includes memory and/or storage modules memory/storage 1256, which also have executable instructions 1204. The hardware layer 1252 may also comprise other hardware 1258.

In the example architecture of FIG. 12, the software architecture 1206 may be conceptualized as a stack of layers where each layer provides particular functionality. For example, the software architecture 1206 may include layers such as an operating system 1202, libraries 1220, applications 1216 and a presentation layer 1214. Operationally, the applications 1216 and/or other components within the layers may invoke application programming interface (API) API calls 1208 through the software stack and receive a response as in response to the API calls 1208. The layers illustrated are representative in nature and not all software architectures have all layers. For example, some mobile or special purpose operating systems may not provide a frameworks/middleware 1218, while others may provide such a layer. Other software architectures may include additional or different layers.

The operating system 1202 may manage hardware resources and provide common services. The operating system 1202 may include, for example, a kernel 1222, services 1224 and drivers 1226. The kernel 1222 may act as an abstraction layer between the hardware and the other software layers. For example, the kernel 1222 may be responsible for memory management, processor management (e.g., scheduling), component management, networking, security settings, and so on. The services 1224 may provide other common services for the other software layers. The drivers 1226 are responsible for controlling or interfacing with the underlying hardware. For instance, the drivers 1226 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1220 provide a common infrastructure that is used by the applications 1216 and/or other components and/or layers. The libraries 1220 provide functionality that allows other software components to perform tasks in an easier fashion than to interface directly with the underlying operating system 1202 functionality (e.g., kernel 1222, services 1224 and/or drivers 1226). The libraries 1220 may include system libraries 1244 (e.g., C standard library) that may provide functions such as memory allocation functions, string manipulation functions, mathematical functions, and the like. In addition, the libraries 1220 may include API libraries 1246 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1220 may also include a wide variety of other libraries 1248 to provide many other APIs to the applications 1216 and other software components/modules.

The frameworks frameworks/middleware 1218 (also sometimes referred to as middleware) provide a higher-level common infrastructure that may be used by the applications 1216 and/or other software components/modules. For example, the frameworks/middleware 1218 may provide various graphic user interface (GUI) functions, high-level resource management, high-level location services, and so forth. The frameworks/middleware 1218 may provide a broad spectrum of other APIs that may be utilized by the applications 1216 and/or other software components/modules, some of which may be specific to a particular operating system or platform.

The applications 1216 include built-in applications 1238 and/or third-party applications 1240. Examples of representative built-in applications 1238 may include, but are not limited to, a contacts application, a browser application, a book reader application, a location application, a media application, a messaging application, and/or a game application. Third-party applications 1240 may include any an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 1240 may invoke the API calls 1208 provided by the mobile operating system (such as operating system 1202) to facilitate functionality described herein.

The applications 1216 may use built in operating system functions (e.g., kernel 1222, services 1224 and/or drivers 1226), libraries 1220, and frameworks/middleware 1218 to create user interfaces to interact with users of the system. Alternatively, or additionally, in some systems interactions with a user may occur through a presentation layer, such as presentation layer 1214. In these systems, the application/component “logic” can be separated from the aspects of the application/component that interact with a user.

Some software architectures use virtual machines. In the example of FIG. 12, this is illustrated by a virtual machine 1210. The virtual machine 1210 creates a software environment where applications/components can execute as if they were executing on a hardware machine (such as the machine 1300 of FIG. 13, for example). The virtual machine 1210 is hosted by a host operating system (operating system (OS) 1236 in FIG. 12) and typically, although not always, has a virtual machine monitor 1260, which manages the operation of the virtual machine as well as the interface with the host operating system (i.e., operating system 1202). A software architecture executes within the virtual machine 1210 such as an operating system operating system (OS) 1236, libraries 1234, frameworks 1232, applications 1230 and/or presentation layer 1228. These layers of software architecture executing within the virtual machine 1210 can be the same as corresponding layers previously described or may be different.

FIG. 13 is a block diagram illustrating components of a machine 1300, according to some example embodiments, able to read instructions from a machine-readable medium (e.g., a machine-readable storage medium) and perform any one or more of the methodologies discussed herein. Specifically, FIG. 13 shows a diagrammatic representation of the machine 1300 in the example form of a computer system, within which instructions 1310 (e.g., software, a program, an application, an appiet, an app, or other executable code) for causing the machine 1300 to perform any one or more of the methodologies discussed herein may be executed. As such, the instructions may be used to implement modules or components described herein. The instructions transform the general, non-programmed machine into a particular machine programmed to carry out the described and illustrated functions in the manner described. In alternative embodiments, the machine 1300 operates as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a user device, a wearable device (e.g., a smart watch), a smart home device (e.g., a smart appliance), other smart devices, a web appliance, a network router, a network switch, a network bridge, or any machine capable of executing the instructions 1310, sequentially or otherwise, that specify actions to be taken by machine 1300. Further, while only a single machine 1300 is illustrated, the term “machine” shall also be taken to include a collection of machines that individually or jointly execute the instructions 1310 to perform any one or more of the methodologies discussed herein.

The machine 1300 may include processors 1304, memory memory/storage 1306, and I/O components 1318, which may be configured to communicate with each other such as via a bus 1302. The memory/storage 1306 may include a memory 1314, such as a main memory, or other memory storage, and a storage unit 1316, both accessible to the processors 1304 such as via the bus 1302. The storage unit 1316 and memory 1314 store the instructions 1310 embodying any one or more of the methodologies or functions described herein. The instructions 1310 may also reside, completely or partially, within the memory 1314, within the storage unit 1316, within at least one of the processors 1304 (e.g., within the processor's cache memory), or any suitable combination thereof, during execution thereof by the machine 1300. Accordingly, the memory 1314, the storage unit 1316, and the memory of processors 1304 are examples of machine-readable media.

The I/O components 1318 may include a wide variety of components to receive input, provide output, produce output, transmit information, exchange information, capture measurements, and so on. The specific I/O components 1318 that are included in a particular machine will depend on the type of machine. For example, portable machines such as mobile phones will likely include a touch input device or other such input mechanisms, while a headless server machine will likely not include such a touch input device. It will be appreciated that the I/O components 1318 may include many other components that are not shown in FIG. 13. The I/O components 1318 are grouped according to functionality merely for simplifying the following discussion and the grouping is in no way limiting. In various example embodiments, the I/O components 1318 may include output components 1326 and input components 1328. The output components 1326 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1328 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1318 may include biometric components 1330, motion components 1334, environmental environment components 1336, or position components 1338 among a wide array of other components. For example, the biometric components 1330 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1334 may include acceleration sensor components (e.g., accelerometer), gravitation sensor components, rotation sensor components (e.g., gyroscope), and so forth. The environment components 1336 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1338 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1318 may include communication components 1340 operable to couple the machine 1300 to a network 1332 or devices 1320 via coupling 1322 and coupling 1324 respectively. For example, the communication components 1340 may include a network interface component or other suitable device to interface with the network 1332. In further examples, communication components 1340 may include wired communication components, wireless communication components, cellular communication components, Near Field. Communication (NFC) components, Bluetooth® components (e.g., Bluetooth® Low Energy), Wi-Fi® components, and other communication components to provide communication via other modalities. The devices 1320 may be another machine or any of a wide variety of peripheral devices (e.g., a peripheral device coupled via a Universal Serial Bus (USB)).

Moreover, the communication components 1340 may detect identifiers or include components operable to detect identifiers. For example, the communication components processors communication components 1340 may include Radio Frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra. Code, UCC RSS-2D bar code, and other optical codes), or acoustic detection components (e.g., microphones to identify tagged audio signals). In addition, a variety of information may be derived via the communication components 1340, such as, location via Internet Protocol (IP) geo-location, location via Wi-Fi® signal triangulation, location via detecting a NFC beacon signal that may indicate a particular location, and so forth.

1. A method comprising:
downloading a card template file to a communications application hosted on a user device;
loading a plurality of card files into a card container within the communications application; and
rendering, using one or more processors, a communications card within the communications application, the rendering of the communications card comprising:
retrieving an application context from the card container and retrieving further data from a plurality of web services;
receiving user input via the communications card; and
communicating the user input from the communications card to the plurality of web services.

2. The method of claim 1, wherein the communications card is rendered using JavaScriptCore.

3. A method to construct a communications card at a communications server, the communications card for use in a card-based chat message stream, comprising:
receiving a card template file at the communications server;
assigning instructions to the card template file for commands and user actions;
packaging, using one or more processors, the card template file for delivery to a communications application on a client device; and
adding the packaged card template file to a card management system associated with an entity.

4. The method of claim 3, wherein the assigning of instructions to the card template file comprises assigning JavaScript code to the card template file for the commands and the user actions,

5. The method of claim 3, wherein the receiving of the card template file at the communications server includes detecting selection of a pre-existing card template file and detecting editing of the pre-existing card template file to generate the received card template file.

6. The method of claim 3, wherein the receiving of the card template file at the communications server includes receiving selection of a first type of standard card template file from a plurality of different types of standard card template files available for selection at the communications server.

7. The method of claim 3, wherein the assigning of instructions to card template file includes assigning JavaScript code to the card template file for the commands and user actions.

8. A method to perform user self-identification within a card-based chat message stream, the method comprising:
at a communications application and from a communications server, receiving, using one or more processors, a request from an agent to a user of the communications application to self-identify, the request including an identity card that is presented to the user via the communications application for input of identification information;
receiving authentication credentials from the user in order to unlock stored identification information stored on a user device associated with the communications application;
responsive to receipt of the authentication credentials, auto-populating the identity card with the stored identification information in order to generate a populated identity card;
receiving from the user a submission indication to submit the populated identity card;
responsive to the submission indication, transmitting of the populated identity card to the communications server in order to authenticate the user; and
displaying acceptance of the populated identity card at the user device.

9. The method of claim 8, wherein the receiving of the authentication credentials includes receiving a security key from the user responsive to a security challenge.

10. The method of claim 9, wherein the security key comprises GridPlus,

11. The method of claim 9, wherein the security key comprises a fingerprint.

12. The method of claim 8, wherein the stored identification information is stored in an encrypted form on the user device associated with the communications application.

13. The method of claim 8, wherein the stored identification information comprises a first identification information having a first degree of protection and second identification information having a second the degree of protection.

14. The method of claim 8, including detecting that no stored identification information on the user device, responsive to the detecting of no stored identification information stored on the user device, prompting the user to input received identification information, and storing the received identification information as the stored identification information.

15. The method of claim 8, wherein the identity card presents a plurality of fields to receive the stored identification information, the quality of fields being auto-populated responsive to receipt of the authentication credentials.

16. The method of claim 8, wherein the identity card presents a business field to receive business-specific information related to a business associated with the agent, the method including receiving the business-specific information from the user into the identity card, and storing of the business-specific information on the user device associated with the communications application.
